(19) United States
(12) Patent Application Publication
(10) Pub. No.: US 2003/0076859 A1
(43) Pub. Date: Apr. 24, 2003

(54) Modification of ciphering activation time by RLC reset procedure during ciphering configuration change procedure in a wireless communications protocol

(76) Inventor: Sam Shiaw-Shiang Jiang, Hsingchu (CN)

Correspondence Address: LU, KAO, 686 Lawson Ave, Havertown, PA, 19083, US

(21) Appl. No.: 10/247,139

(22) Filed: Sep. 19, 2002

Related U.S. Application Data
(60) Provisional application No. 60/335,774, filed on Oct. 23, 2001.

(51) Int. Cl. H04J 3/06

(52) U.S. Cl. 370/509

(57) ABSTRACT

This invention improves channel synchronization during a channel reset in a ciphering-deciphering wireless communication system. In the prior art at least in four situations, there is no well-defined or effective rules to ensure the channel synchronization after a channel reset between connected stations. This invention provide a method and a system to fulfill the gaps by clearly defining which and when a new cipher key for ciphering/deciphering shall be applied at either the receiving side or the transmitting side of the connected stations. This invention provides clear defined rules to eliminate these uncertainties so as to establish a more stable and effective communication system.

### CROSS REFERENCE APPLICATION

This application claims priority from U.S. Provisional Patent Application No. 60/335,774 filed on Oct. 23, 2001.

### BACKGROUND

The present invention relates to a wireless communications protocol. In particular, the present invention discloses a method of handling a channel reset conditions while processing a ciphering configuration change in a wireless communications protocol.

In a wireless communication system, Stations 10, 20, as shown in FIG. 1, use several of their multi-channels to communicate with each other. The channel 12i of the station 10 is connecting with the channel 22i of the station 20 through linkage 18, while the channel 12j is connecting to the channel 22j of the station 20 through linkage 19. To establish communication between both stations 10,20, the corresponding channels have to be synchronized with the same transmitting format, speed and the encryption/encipher and decrypted/deciphered scheme between themselves, whether it transmits data, voice or network system commands. All transmitting data is packaged in the form of protocol data units (PDUs). For example, refer back to FIG. 1, the first station 10 may be a base station, while the second station 20 is a mobile unit, such as a cellular telephone. The linkage 18 is a data transmitting linkage between the station 10 and the station 20. While the linkage 19, a signaling transmitting linkage, is dedicated to be used to exchange protocol signaling data, such as system commands or network commands between the first station 10 and the second station 10. There may be other channel linkages, which are used by the system for broadcasting, data transmitting or other purposes. No matter what the purpose of the linkages is, each channel 12i-o of the station 10 and channels 22i-o of the station 20 has its own receiving buffer 12r, 22r for holding received PDUs 11r, 21r. And a transmitting buffer 12t, 22t for holding PDUs 11t, 21t that are waiting to be transmitted out. As shown in FIG. 1, the station 10 stores a PDU 11t in the transmitting buffer 12t and later sends the PDU by its channel 12i out, through the linkage 18 to the station 20. The second station 20 receives the PDU 11t by its channel 22i and generates PDU 21r, a mirror-image package of PDU 11t, to store in its receiving buffer 22r. Similarly, in a bi-directional linkage, PDUs to be sent out will be stored in each channels' transmitting buffer 11t, 21t. Meantime, PDUs received are stored in each channels' receiving buffer 11r, 21r to be processed later.

Once a particular linkage is synchronized, the data structures of pair entity PDUs 11t, 21r, and 21t, 11r along corresponding channels 12 and 22 are identical. The system allows different channels 12i-o, 22i-o to use different PDU data structures according to the type of connection agreed upon between corresponding channels. For a better monitoring purpose, Each channel assigns its transmitting PDUs 11t, 11r, 21r 21t with a respective m-bit sequence number 5t, 5r, 6r, 6t. The m-bit sequence number 5r, 5t, 6r, 6t is part of the PDU 11r, 11t, 21r, 21t data structure. In an acknowledged mode (AM), the station 10 sends out each PDU assigned with a 12-bit sequence number 5t assigned. On the receiving side, the second station 20 checks the sequence numbers 6r of the received PDUs 21r, which is the mirror image of the PDU 11t. Then the second station 20 returns to the first station 10 either a corresponding acknowledge message to indicate the particular sequence numbered PDU 21r is successfully received, or may request that a PDU 11t be re-transmitted by specifying the requested sequence number 5t of the PDU 11t. Alternatively, in an unacknowledged transmission mode (UM), it differs from AM mode by not returning an acknowledgment message if a PDU is successfully received. Although in this application we use the communication flow from the station 10 to the station 20 in most examples, the principle and solution can be implied and apply to communication flow from the station 10 to the station 20.

To further ensure secure and private exchanges of data exclusively between the first station 10 and the second station 20. Encrypt/encipher of sending PDUs and decrypt/decipher of receiving PDUs are implemented in both stations 10, 20. As shown in FIG. 1, every station 10, 20 has one ciphering engine 14, 24. All channels of one station will use the station's ciphering engine to perform encipher or decipher its sending and receiving PDUs. In the linkage 18, the first station 10 will encrypt the sending PDUs 11t with its ciphering engine 14 with a particular ciphering key 14k. When received the encrypted PDUs, the station 20 at the receiving side has to uses its ciphering engine 24 with the ciphering key 24k, which is identical to ciphering key 14k, to decipher these encrypted PDUs 21r. The ciphering keys 14k, 24k remain constant across all PDUs 11t, 21t (and thus corresponding PDUs 21r, 11r) and channels 12,22, until explicitly changed by both the first station 10 and the second station 20. Outs off sync of using different keys to cipher and decipher between stations produce meaningless data. There are several situations when ciphering keys between stations have to be resynchronized. It happens at the initialization stage of communication. It also happens periodically when an old ciphering key 14k, 24k is switched to a new one for security purpose. The system uses the predetermined security interval 14x at station 10 and its corresponding security interval 24x at station 20 to trace such connected-channel periodically changes. The predetermined security interval 14x, 24x may depend upon an actual elapsed time-of-use of the ciphering key 14k, 24k, or upon a usage count of the ciphering key 14k, 24k.

The system uses either a channel reset process (Reset) or a security-mode channel re-establishment process (Re-establishment) to invoke the ciphering parameter (e.g. COUNT-C, which includes HFN and Sequential Number (SN)) re-synchronization. Although both reset and re-establishment are supported in an AM channel, whereas only re-establishment is supported in an UM channel. Both Reset and Re-establishment perform ciphering parameter re-synchronization but they are different with each other. However, it should be understood that the term Reset in this application represents either a channel reset or a re-establishment process in AM mode or a channel re-establishment process in UM mode. A Reset (or Re-establishment) occurs when either the first station 10 or the second station 20 detects errors along a respective channel 12, 22, perhaps due to synchronization problems or reception problems. Resetting of a channel 12, 22 places the channel 12, 22 into reconfiguration process, such as resetting the SN to the value of 0, and invokes the exchanges of ciphering parameters between stations through. Reset process can be initialized by either stations 10, 20. The base station, i.e., the first station 10, typically initiates the security mode reconfiguration process.

Because every station can invoke the channel reset process to reset the channel-connected both stations, it could lead to several complicate conditions. For example, the first station 10 may decide to reset channels 12i and 22i, meantime, the second station 20 may decide to reset channels 22j and 12j. In addition, when an established channel 12, 22 exceeds the security intervals 14x, 24x the first station 10 (i.e., the base station) may initiate a security mode reconfiguration process to change the old ciphering key 14k, 24k to a new and different ciphering key 14n, 24n. The point or timing for changing over to the new ciphering keys 14n, 24n must be carefully synchronized across all channels 12, 22 to ensure that transmitted PDUs lit, 21t are properly deciphered into received PDUs 21r, 11r.

All connecting channels between the station 10 and the station 20 can be switched to use the new ciphering key at different delay times. This can be accomplished by using a so-called ciphering activation time (CAT) or simply activation time 17t, 27r for each channel 12, 22. The activation time 17t, 27r is simply a sequence number value 5t, 6r of PDUs 11t, 21r and may be different for different channels. The system will use a security mode command (SMC) to pass the CATs and new ciphering configuration information between stations. To generate the security mode command, the first station 10 determines an activation time 17t for the transmitting buffer 12t of each channel 12. As shown in FIG. 2, assume that the current system is running with an old ciphering configuration for connecting channels. FIG. 2 illustrates a normal ciphering configuration change flow diagram between stations. At the step 1, the station 10 prepares the SMC including the new ciphering configuration to be used (e.g. start/restart or stop ciphering, ciphering algorithm), and the activation times 17t. Data transmitting by the station 10 to station 20 is called Downlink (DL) and data transmitting by the station 20 to the station 10 is called Uplink (UL). Therefore, the activation time 17t, 27r is abbreviated as DL CAT. Then the station 10 will suspend all other channels' services for transmitted PDUs with SN equal to or greater than their corresponding DL CATs except the dedicated signaling radio bearer (SRB) for this particular SMC command. Meantime, at step 2, the station 20 processes PDUs with the current/old ciphering configuration normally. At the step 3, the station 10 prepares a Security Mode Command (SMC) with DL CATs and the new ciphering configuration. At the step 4, the particular SMC is sent over the signaling radio bearer (SRB) to the station 20. The station 20 also prepares a radio link control (RLC) acknowledgment (ACK) report in response to the received SMC (step 5). The station 20 sends the first RLC ACK through the signaling channel to the station 10 (step 7). In the step 6, the station 20 decodes and processes the received SMC, which contains the new ciphering configuration and the DL CATs. At the station 20 side (after step 6), all buffered received downlink PDUs in all channels are processed under the current/old ciphering configuration as long as their SNs are smaller than the corresponding DL CATs and under the new ciphering configuration for PDUs with SNs equal to or greater than the corresponding DL CATs. At the step 8, once the station 10 receives the first RLC ACK, it resumes all suspended RBs/SRBs, i.e. releases the prohibition of transmitting downlink PDUs with SNs equal to or greater than the corresponding DL CATs, and process the transmitted downlink PDUs with the old ciphering configuration as long as their SN is smaller than DL CAT, otherwise, it starts to process them with the new ciphering configuration. Running in a concurrent state, the station 20, at step 9, suspends RBs/SRBs except the SMC-carry SRB and decides the UL CATs for each RB and each SRB including the SMC-carry SRB. The station 20 prepares (step 10) a Security Mode Completed message and sends it to the station 10 (step 11). The station 10 prepares the second RLC ACK report in response to the received Security Mode Complete message in step 12. After step 12, the station 10 processed all buffered received uplink PDUs in all channels with the old ciphering configuration as long as their SNs are smaller than the corresponding UL CATs, otherwise, it starts to process them with the new ciphering configuration. And in the step 13 the station 10 sends the RLC ACK message over the signaling radio bearer back to the station 20. Once the station 20 receives the second RLC ACK report sent by the station 10, in step 14, the station 20 will resume all suspended channels' services, i.e. releases the prohibition of transmitting uplink PDUs with SNs equal to or greater than the corresponding UL CATs, and processes all transmitted PDUs with the old ciphering configuration as long as their SN is smaller than the DL CAT and with the new ciphering configuration as long as their SN is equal to or greater than the DL CAT. In summary, channels of both stations 10, 20 will use the new ciphering configuration to process the PDUs according to DL CAT and UL CAT. Using the first station 10 as an example, for all PDUs 11t that have sequence number 5t that are prior to the activation time 17t (DL CAT) for their channel 12, the PDUs 11t are enciphered using the old ciphering key 14k. For PDUs 11t, which have sequence numbers 5t that are sequentially on or after the activation time 17t (DL CAT), the new ciphering key 14n is applied for enciphering. When receiving the PDUs 21r, the second station 20 uses the sequence numbers 6r and the activation time 27r (DL CAT) to determine which key 24k or 24n to use for the deciphering of the PDUs 21r. A similar transmitting process also occurs on the second station 20, with each channel 22 having the activation time 27t (UL CAT), and each corresponding receiving buffer 12r on the first station 10 having an identical activation time 17r (UL CAT). The security mode reconfiguration process thus provides for synchronization of the activation times 17r with 27t, and 17t with 27r, so that the second station 20 and first station 10 may know when to apply their respective ciphering keys 24n, 24k and 14n, 14k to received PDUs 21r, 11r and transmitted PDUs 21t, 11t.

Determination of the activation times 17t, 27t is relatively straightforward. As shown in FIG. 1, each transmitting buffer 12t, 22t has a state variable VT(S) 12v, 22v. Each state variable VT(S) 12v, 22v holds the sequence number 5t, 6t of a PDU 11t, 21t that is next to be transmitted for the first time along the respective channel 12, 22 of the transmitting buffer 12t, 22t. The first station 10 initially estimates how much time, in terms of transmitted PDUs 11t, is required to complete the security mode reconfiguration process, a parameter N. For each channel 12, including the signaling channel 12s, the first station 10 then adds N to the VT(S) 12v for that channel 12 to generate the respective activation time 17t. The activation times 17t are then placed in the security mode command and sent, via the signaling channel 12s, to the second station 20. Similarly, the second station 20 uses a corresponding parameter N, and VT(S) 22v for each channel 22, to generate the respective activation times 27t. The activation times 27t are then placed in the security mode complete message and sent, via channel 22s, to the first station 10. The addition of N to VT(S) 12v, 22v is a bit-wise addition without carry. That is, if the value of VT(S)+N exceeds the bit-size of VT(S) 12v, 22v then the activation 17t, 27t time will roll-over past zero. The activation time 17t, 27t may thus be thought of as: (VT(S)+N) mod 2m, where m is the bit size of VT(S) 17t, 27t, i.e., the bit size of the sequence numbers 5t, 6t.

In response to a reset event, the state variables VT(S) 12v and 22v for corresponding channels 12 and 22 are cleared to zero. If reset procedure happens after the security mode complete message is acknowledged in the station 20, the activation times 27r, 27t for the channel 12, 22 being reset are ignored after the reset procedure i.e., the channel 12, 22 being reset immediately adopts the new ciphering configuration. For example, imagine a channel 22 having VT(S) 22v equal to 140, and an activation time 27t (UL CAT) of 150. The next ten PDUs 27t (PDUs 27t with sequence numbers 6t from 140 to 149) should be transmitted using the old ciphering configuration, i.e., enciphered using the ciphering key 24k. PDUs 27t with sequence numbers 6t from 150 and onwards should be enciphered under the new ciphering configuration, using the new ciphering key 24n. However, if this channel 22 is reset after the security mode complete message is acknowledged, VT(S) 22v is set to zero, and the activation time 27t is then ignored so that the new ciphering configuration is immediately used. At the station 20, it is defined that, any time a channel 22 is reset after the security mode complete message is acknowledged (Step 14 in FIG. 2), the channel 22 being reset must immediately apply the new ciphering configuration to all subsequently transmitted PDUs 21t and received PDUs 21r. At the station 10, it is defined that, any time a channel 12 is reset after the security mode complete message is received (Step 12 in FIG. 2), the channel 12 being reset must immediately apply the new ciphering configuration to all subsequently transmitted PDUs 11t and received PDUs 11r. However, it is not clear if a channel reset happens in other stages of ciphering reconfiguration operation. The application addresses a method to deal such uncertainty.

### SUMMARY

In the prior art, at least in four identified situations, there is no well-defined or effective method to improve the channel synchronization during a channel reset between connected stations in a ciphering-deciphering wireless communication system. This invention provides a clear defined rules to eliminate these uncertainties, therefore, establishes a more stable and effective communication system.

### BRIEF DESCRIPTION OF THE DRAWINGS

FIG. 1 is a simplified block diagram of a wireless communications system.

FIGS. 1A-1D illustrate different functional block diagrams of a station's components.

FIG. 2 illustrates a normal ciphering configuration change flow diagram between stations.

### DETAIL DESCRIPTION OF THE INVENTION

In the following description, a station may be a mobile telephone, a handhold transceiver, a base station, a personal data assistant (PDA), a computer, or any other device that requires a wireless exchange of data. It should be understood that many means may be used for the physical layer to effect wireless transmissions, and that any such means may be used for the system hereinafter disclosed.

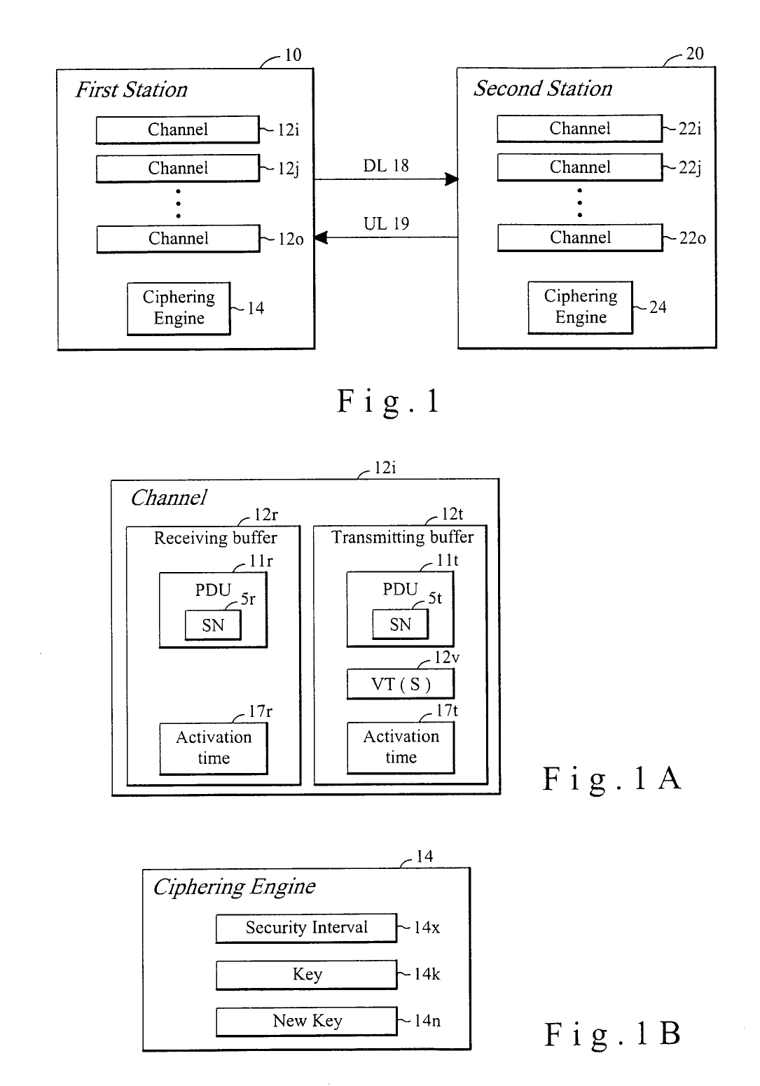

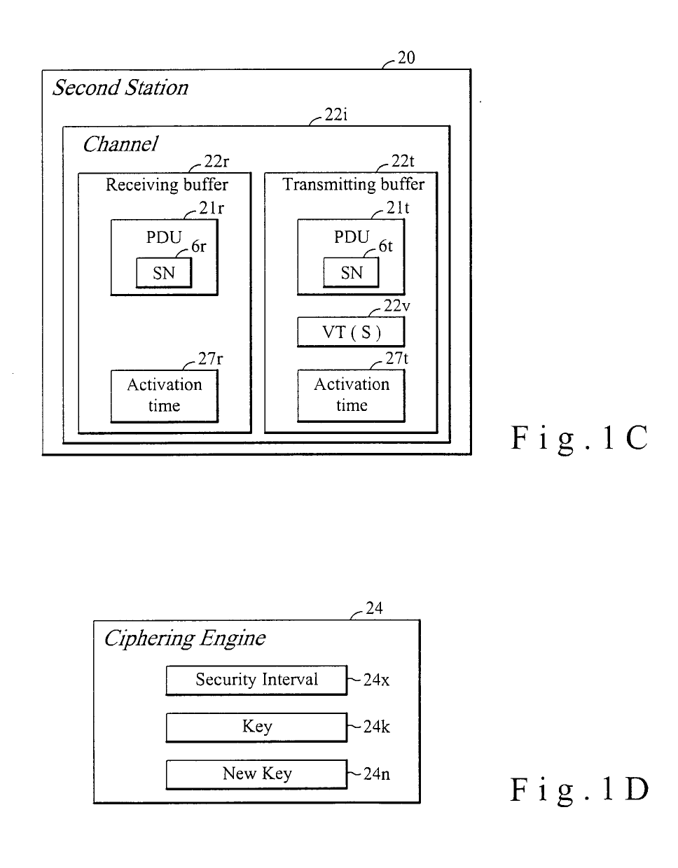

In most situations, this immediate use of the new ciphering configuration for a channel 12, 22 that has been reset poses no problems. As shown in the FIG. 1, in a normal condition, the base station 10 decides that the security interval 14x has been exceeded, and so transmits a security mode command to the mobile unit 20, in the form of one or more PDUs 11t along the channel 12s. The mobile unit 20 sends acknowledgment of the successful reception of the security mode command PDUs 11t to the base station 10. A channel 12, 22 is then reset, initiated by either the base station 10 or the mobile unit 20. A reset happens at this point, the new ciphering configuration should be immediately applied on the downlink to the reset channel 12 by the base station 10, and to corresponding reset channel 22 by the mobile unit 20.

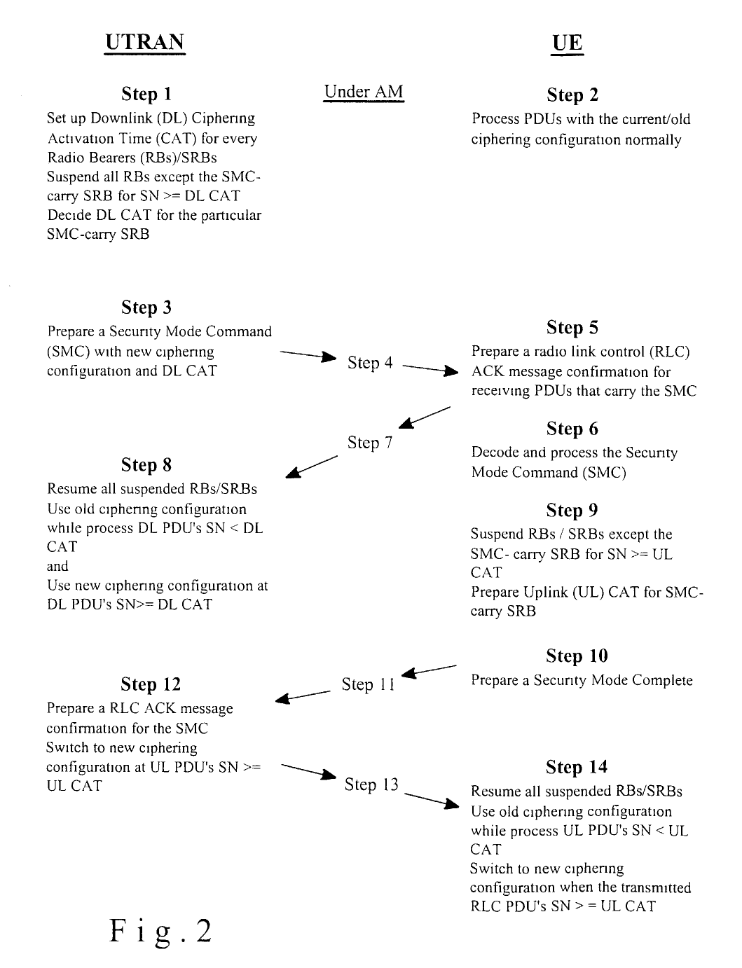

However, under certain conditions, problems may occur. A Reset or Re-establishment can happen at any stage of the ciphering configuration change procedure. If the system parameters such as, the DL CAT, UL CAT and the corresponding SN of transmitting PDUs, are not clearly and well defined during Reset, an unexpected Reset could cause the miscommunication between stations and it takes time to recover. For example, as shown in FIG. 2, There are several places where the system parameters could become uncertain if a Reset happens.

The system parameters of following situations should be addressed during a Reset, otherwise, the communication between the station 10 and station 20 may be jeopardized or take a longer time to recover because the undefined condition.

(1) In the station 20, a reset command, issued by either station 10 or 20, presents after the station 20 prepared and sent a Security Mode Complete message (step 10 of FIG. 2), but before the station 20 receives the RLC ACK for the Security Mode Complete message from the second station 10 (step 14 of FIG. 2).

(2) In the station 20, a reset command, issued by either station 10 or 20, presents after the station 20 decodes and processes the received Security Mode Command message sent by the station 10 (step 6 of FIG. 2), but before the station 20 prepares and sends a Security Mode Complete message (step 10 of FIG. 2).

(3) In the station 10, a reset command, issued by either station 10 or 20, presents after the station 10 received the RLC ACK for the Security Mode Command message (step 8 of FIG. 2), but before the station 10 receives a Security Mode Complete message (step 12 of FIG. 2).

(4) In the station 10, a reset command, issued by either station 10 or 20, presents after the station 10 sent the Security Mode Command message (step 3 of FIG. 2), but before the station 10 receives the RLC ACK for the Security Mode Command message (step 8 of FIG. 2).

When a Reset occurs in these above-defined cases, the new system will apply the following solution for these system parameters to eliminate uncertainty.

In case (1) situation, the station 20 will, for the RB being reset, ignore both the DL CAT and UL CAT and apply the new ciphering configuration immediately after the reset process.

In the cases (2) situation the station 20, at its receiving side, should, for the RB being reset, ignore the DL CAT and apply the new ciphering configuration immediately after the reset process. At its transmitting side, the station 20 should suspend the RB being reset at SN=0 and set the UL CAT for this RB with a value of 0.

In the cases (3) and (4) situations, the station 10 will, for the RB being reset, ignore both the DL CAT and UL CAT, apply the new ciphering configuration immediately after reset process.

Although we explain the whole operation involved with resetting AM systems, the solution can be applied to the operation involved with reestablishing AM systems and with re-establishing UM systems.

What is claimed is:

1. A method of improving channel synchronization during a channel reset between a first station and a second station in a ciphering-deciphering wireless communication system, where each station having a transmitting side for buffering encrypted Sequence Number (SN) assigned data packages before sending them out to the other station, a receiving side for receiving and buffering received encrypted data packages from other station, and a cipher engine using switchable cipher keys to cipher/decipher these sending and received data packages; the first station initializing and synchronizing a new cipher key selection by sending the second station through a dedicated channel a first network command containing at least a new key activation counter containing the SN of a data package that the new cipher configuration will be used by the cipher engine to ciphering/deciphering the sending and received data packages, a channel reset happened after the first network command was sent, the method comprising the steps of:
the second station receiving the first network command;
the channel-connected stations responding with different corresponding processes of switching to use the new cipher configuration depending on the exact timing of the channel reset occurrence.

2. The method of claim 1, wherein the channel reset happens in a channel that is in an Acknowledge mode.

3. The method of claim 1, wherein the channel reset happens in a channel that is in an Unacknowledge mode.

4. The method of claim 1, wherein the channel-connected stations responding with different corresponding processes further comprises the steps of:
the second station preparing a second network command; and
the second station sending the second network command to the first station through the dedicated channel.

5. The method of claim 4, wherein the channel reset occurring after the second station received the first network command and before the second station preparing the second network command, wherein the channel-connected stations responding with different corresponding processes further comprising the steps of:
only the receiving side of the second station applying the new cipher configuration immediately; and
the transmitting side of the second station setting SN=O and the new key activation counter=0.

6. The method of claim 1, wherein the channel-connected stations responding with different corresponding processes further comprising the steps of:
the second station sending a first Acknowledge (ACK) to the first station;
the first station receiving the first ACK;
the second station preparing and sending a second network command to the first station through the dedicated channel;
the first station receiving the second network command;
the first station sending a second ACK to the second station; and
the second station receiving the second ACK.

7. The method of claim 6, the channel reset occurring after the second station sent the second network command and before the second station receiving the second ACK, wherein the channel-connected stations responding with different corresponding processes further comprising the second station immediately switching to use the new cipher configuration at both the transmitting and the receiving sides of the second station.

8. The method of claim 6, the channel reset occurring after the first station receiving the first ACK and before the first station receiving the second network command, wherein the channel-connected stations responding with different corresponding processes further comprising the first station switching to use the new cipher configuration immediately at both the transmitting and the receiving sides of the first station.

9. The method of claim 6, the channel reset happening after the first station sent the first network command and before the first station receiving the first ACK, wherein the channel-connected stations responding with different corresponding processes further comprising the first station switches to use the new cipher configuration immediately at both the transmitting and the receiving sides of the transmitting station.

10. A system having means for improving channel synchronization during a channel reset between a first station and a second station in a ciphering-deciphering wireless communication system, where each station having a transmitting side for buffering encrypted Sequence Number (SN) assigned data packages before sending them out to the other station, a receiving side for receiving and buffering received encrypted data packages from other station, and a cipher engine using switchable cipher keys to cipher/decipher these sending and received data packages; the first station having means for initializing and synchronizing a new cipher key selection by sending the second station through a dedicated channel a first network command containing at least a new key activation counter containing the SN of a data package that the new cipher configuration will be used by the cipher engine to ciphering/deciphering the sending and received data packages, a channel reset happened after the first network command was sent, the system comprising:
means for receiving the first network by the second station; and
the channel-connected stations having means for responding with different corresponding processes of switching to use the new cipher configuration depending on the exact timing of the channel reset occurrence.

11. The system of claim 10, wherein the channel-connected stations having means for responding with different corresponding processes wherein the second station further comprises:
means for preparing a second network command; and
means for sending the second network command to the first station through the dedicated channel.

12. The system of claim 11, wherein the channel reset occurring after the second station received the first network command and before the second station preparing the second network command, wherein the channel-connected stations having means for responding with different corresponding processes wherein the second station further comprising:
only the receiving side of the second station having means for applying the new cipher configuration immediately; and
the transmitting side of the second station having means for setting SN=0 and the new key activation counter=0.

13. The system of claim 11, wherein the channel-connected stations having means for responding with different corresponding processes further comprising:
the second station comprising:
means for sending a first Acknowledge (ACK) to the first station;
means for preparing and sending a second network command to the first station through the dedicated channel; and
means for receiving the second ACK. and
the first station comprising:
means for receiving the first ACK;
means for receiving the second network command; and
means for sending a second ACK to the second station.

14. The system of claim 13, the channel reset occurring after the second station sent the second network command and before the second station receiving the second ACK, wherein the channel-connected stations having means for responding with different corresponding processes further comprising the second station having means for immediately switching to use the new cipher configuration at both the transmitting and the receiving sides of the second station.

15. The system of claim 13, the channel reset occurring after the first station receiving the first ACK and before the first station receiving the second network command, wherein the channel-connected stations having means for responding with different corresponding processes is that the first station having means for switching to use the new cipher configuration immediately at both the transmitting and the receiving sides of the first station.

16. The system of claim 13, the channel reset happening after the first station sent the first network command and before the first station receiving the first ACK, wherein the channel-connected stations having means for responding with different corresponding processes is that the first station having means for switches to use the new cipher configuration immediately at both the transmitting and the receiving sides of the transmitting station.
